(19) United States
(12) Patent Application Publication
(10) Pub. No.: US 2017/0139973 A1
(43) Pub. Date: May 18, 2017

(54) METHOD AND DEVICE FOR SYNCHRONOUSLY UPDATING CONTACT INFORMATION

(71) Applicants: LE HOLDINGS (BEIJING) CO., LTD., Beijing (CN); Lemobile Information Technology (Beijing) Co., Ltd., Beijing (CN)

(72) Inventor: Haining HUANG, Beijing (CN)

(21) Appl. No.: 15/247,836

(22) Filed: Aug. 25, 2016

Related U.S. Application Data
(63) Continuation of application No. PCT/CN2016/087404, filed on Jun. 28, 2016.

(30) Foreign Application Priority Data
Nov. 13, 2015 (CN) 201510781127.6

(51) Int. Cl. G06F 17/30; H04L 29/12; H04L 29/08

(52) U.S. Cl. CPC G06F 17/30368; H04L 67/10; H04L 61/1594; G06F 17/30371; G06F 17/30365

(57) ABSTRACT

The present disclosure discloses a method and device for synchronously updating contact number. The method includes: detecting whether the contact information of the user is changed: when the contact information of the user is changed, updating the cloud account contact information of the user, and sending, an invitation for synchronously updating the contact information to the terminal device of at least one target user in the cloud account address book of the user; when any one of the target user accepts the invitation, updating the cloud account address book of the target user accepted the invitation, and synchronously updating the corresponding terminal device address book by the cloud account of the target user accepted the invitation. The present disclosure uses the interne properties of the cloud service, which satisfies the need of communication between the user, and improves the user's experience.

### CROSS-REFERENCE TO RELATED APPLICATIONS

This application is a continuation of International Application No. PCT/CN2016/087404, tiled on Jun. 28, 2016; which is based upon and claims priority to Chinese Patent Application No. 201510781127.6, entitled “A METHOD AND DEVICE FOR SYNCHRONOUSLY UPDATING CONTACT INFORMATION”, filed on Nov. 13, 2015, the entire contents of all of which are incorporated herein by reference.

### FIELD OF TECHNOLOGY

The present disclosure generally relates to a cloud service technical field, particularly relates to a method and device for synchronously updating contact information.

### BACKGROUND

With the continuous development of the mobile internet and terminal device (such as cell phone, pad, etc.) technology, the cloud service is accepted and used by more and more people. Wherein, the cloud backup function is increasingly used in the backup function of materials, such as photo, address book, etc.

Referring to FIG. 1, in the existing cloud backup schemes, the user stores and backups the local address book and the like of the terminal device under his own cloud account, i.e. the user uploads the materials such as the address book in his own terminal device to the cloud server to store the backup, and downloads and synchronizes to the local from the cloud server when needed.

However, the existing cloud schemes still have the following defects:

In the real life, the user generally would encounter such scene: after the user changes the cell phone number; he must inform the relatives and friends one by one about the Changed new number through various ways such as cell phone, short message, and social internet. It is not only tedious but also inefficient. Otherwise, he encounters such scene: the user picks up the cell phone and calls an estranged friend, and realizes that it is a vacant number. The existing cloud schemes cannot play any role with respect to the above scenes, i.e. when the user's cell phone number is changed, it is unable to solve the problems of timely updating the address book corresponded by the user in the address hook, thereby resulting in a poor communication between the user and a bad user experience. Therefore, it is very necessary to improve the existing cloud schemes.

### SUMMARY

An embodiment of the present disclosure discloses a method and device for synchronous updating contact number in order to solve the problem of the present cloud backup scheme that it is unable to solve the problem of timely Updating the address book corresponded by the user in the address book when the user's cell phone number is changed, thereby resulting in the poor communication between the user, and bad user experience.

According to one aspect of the present disclosure, the embodiments of the present disclosure disclose a method for synchronously updating contact information, including the following steps: detecting whether the contact information of the user :is changed; when the contact information of the user is changed, updating the cloud account contact information of the user, and sending the invitation for synchronously updating the contact information to the terminal device of at least one target user in the cloud account address book of the user; wherein, the cloud account of the at least one target user and the cloud account of the user are under the same cloud server, and the cloud account address book of each of the target user includes the contact information of the user before change; when any one of the target user accepts the invitation, updating the cloud account address book of the target user who accepts the invitation, and synchronously updating the corresponding terminal device address book through the cloud account of the target user who accepts the invitation.

According to another aspect of the present disclosure, the embodiments of the present disclosure further disclose an electronic device firm synchronously updating contact information, including: at least one processor; and a memory communicably connected with the at least one processor for storing instructions executable by the at least one processor, wherein execution of the instructions by the at least one processor causes the at least one processor to: detect whether the contact information of user is changed; when the contact information of the user is changed, update the cloud account contact information of the user, and send the invitation for synchronously updating the contact information to the terminal device of at least one target user in the cloud account address book of the user; wherein, the cloud account of the at least one target user and the cloud account of the user are in the same cloud server, and the cloud account address book of each of the target user comprise the contact information of the user before changed; when any one of the target user accepts the invitation, update the cloud account address book of the target user accepted the invitation, and synchronously update the corresponding terminal device address book by the cloud account of the target user accepted the invitation.

According to another aspect of the present disclosure, a computer program including the computer readable code is provided. When the computer readable code is operated on the server, it will make the server carry out the above method for synchronously updating contact information.

According to another aspect of the present disclosure, there is disclosed a non-transitory computer-readable medium storing executable instructions that, when executed by a computing device, cause the computing device to: detect whether the contact information of user is changed; when the contact information of the user is changed, update the cloud account contact information of the user, and send the invitation for synchronously updating the contact information to the terminal device of at least one target user in the cloud account address hook of the user; wherein, the cloud account of the at least one target user and the cloud account of the user are in the same cloud server, and the cloud account address hook of each of the target user comprise the contact information of the user before changed; when any one of the target user accepts the invitation, update the cloud account address book of the target user accepted the invitation, and synchronously update the corresponding terminal device address book by the cloud account of the target user accepted the invitation.

The beneficial effect of the present disclosure is:

the embodiments of the present disclosure provide a method and device for synchronous updating contact information to detect whether the contact information of the user is changed; wherein when the contact information of the user is changed, updating the cloud account contact information of the user, and sending the invitation for synchronously updating the contact information to the terminal device of at least one target user under the cloud account address book of the user; wherein, the cloud account of the at least one target user and the cloud account of the user are under the same cloud server, and the cloud account address book of each of the target user includes the contact information of the user before change, and when any one of the target user accepts the invitation, updating the cloud account address book, of the target user who accepts the invitation, and synchronously updating the corresponding terminal device address book through the cloud account of the target user who accepts the invitation. Thereby, when the contact information of any one of the user is changed, all the target users under the cloud server can automatically receive the contact information synchronous update invitation, and can update the address book of the target user who accepts the invitation in time, thereby avoiding the problem of poor communication between the user, and improve user experience.

The above description is only the summary of the technical scheme of the present disclosure. In order to more clearly understand the technical means of the present disclosure, it can be carried out according to the contents of the description. Moreover, in order to make the above-mentioned and other purposes of the present disclosure more obvious and understandable, the detailed description of the embodiments of the present disclosure are listed as follows.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of the existing cloud backup scheme.

FIG. 2 is a step flow diagram of an embodiment of the method for synchronously updating contact information of the present disclosure.

FIG. 3 is a step flow diagram of another embodiment of the method of a synchronously updating contact information of the present disclosure.

FIG. 4 is a schematic diagram of cloud backup scheme in the specific embodiments of another method for synchronously updating contact information.

FIG. 5 is a step flow diagram of the specific embodiments of another method for synchronously updating contact information.

FIG. 6 is a structure diagram of an embodiment of the device for synchronously updating contact information of the present disclosure.

FIG. 7 is a structure diagram of another embodiment of the device for synchronously updating contact information of the present disclosure.

FIG. 8 is a schematic diagram for carrying out an electronic device according to steps of the method of the present disclosure.

FIG. 9 schematically shows the storage unit for holding or carrying the program code according to the method of the present disclosure.

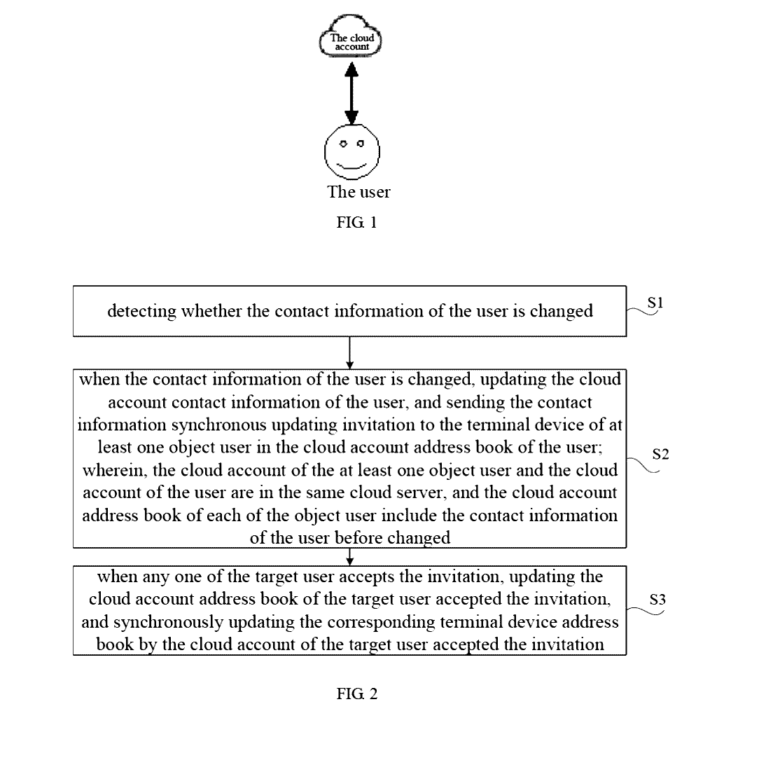

### DETAILED DESCRIPTION

In order to make the purpose, technical scheme and advantage of the embodiments of the present disclosure clearer, the technical scheme in the embodiments of the present disclosure is clearly and entirely described in the following, in combination with the figures in the embodiments of the present disclosure. Obviously, the described embodiments are only part of embodiments of the present disclosure, rather than all the embodiments. Based on the embodiments of the present disclosure, all the other embodiments obtained by a person skilled in the art without paying any creative work belong to the protection scope of the present disclosure.

The method and device for synchronously updating contact information of the embodiments of the present disclosure can be applied to the cloud server.

Referring to FIG. 2, a step flow diagram of an embodiment of the method for synchronously updating contact information of the present disclosure is shown. The method for synchronously updating contact information can include the steps as follows.

S1, detecting whether the contact information of the user is changed.

Wherein, the contact information can include telephone number and/or cell phone number and/or social account such as QQ number, WeChat, etc.

S2, when the contact information of the user is changed, updating the cloud account contact information of the user, and sending the contact information synchronous update invitation to the terminal device of at least one target user under the cloud account address book of the user; wherein, the cloud account of the at least one target user and the cloud account of the user are under the same cloud server, and the cloud account address book of each of the target user include the contact information of the user before change.

Wherein, the cloud account contact information of the user is the contact information stored in the cloud account of the user, the cloud address book of the user is the address book stored in the cloud account of the user. Specifically, the terminal device of at least one target user can be cell phone, etc. Specifically, the forms of the contact information synchronous update invitation can include one or more form of the short message, the pushing information of the application program, the pushing information of the social system, etc.

Since the cloud account address book of the user includes the contact information of at least one target user, and the cloud account address book of each of the target user includes the contact information of the user before change, i.e. the user and each target user used to keep in touch, for example, the user and each of the target user are friends. Therefore, step S2 sends the contact information synchronous update invitation to the terminal device of at least one user in the cloud account address book of the user, and it can omit the trouble that the user informs at least one target user one by one that his contact information is changed. Further, when the target user accepts the invitation, it means that the target user who accepts the invitation needs to keep in touch with the user and enters into the step S3.

S3, when any target user accepts the invitation, updating the cloud account address book of the target user who accepts the invitation, and synchronously updating the corresponding terminal device address book through the cloud account of the target user who accepts the invitation.

Wherein, step S3 updates the cloud account address book of the target user who accepts the invitation, it can replace the contact information of the user before change in the cloud account address book with the contact information of the user after change. Step S3 synchronously updates the corresponding terminal device address book through the cloud account of the target user who receives the invitation, it can be for the cloud account of the target user received the invitation, replace the contact information of the user before change in the cloud account address book with the contact information of the user after change, or replace the terminal device address account with updated cloud account address book.

According to the Embodiment one of the present disclosure, after detecting whether the contact information of the user such as telephone number and/or social account is changed, when the contact information of the user is changed, updating the cloud account contact information of the user and sending the contact information synchronous update invitation to the terminal device of at least one target user in the cloud account address book of the user; wherein, the cloud account of the at least one target user and the cloud account of the user are in the same cloud server, and the cloud account address book of each of the target user includes the contact information of the user before change, and when any one of the target user accepts the invitation, updating the cloud account address book of the target user who accepts the invitation and synchronously updating the corresponding terminal device address book by the cloud account of the target user who accepts the invitation. Thereby, when the contact information of any one of the user is changed, all of the target user under the cloud server can automatically receive the contact information synchronous update invitation, which saves the trouble that the user informs the target user one by one that the contact information is changed, and can timely update the address book and the terminal device address book of the target user who accepts the invitation, thereby avoiding the problem of poor communication between the user, and improve user experience.

### Second Embodiment

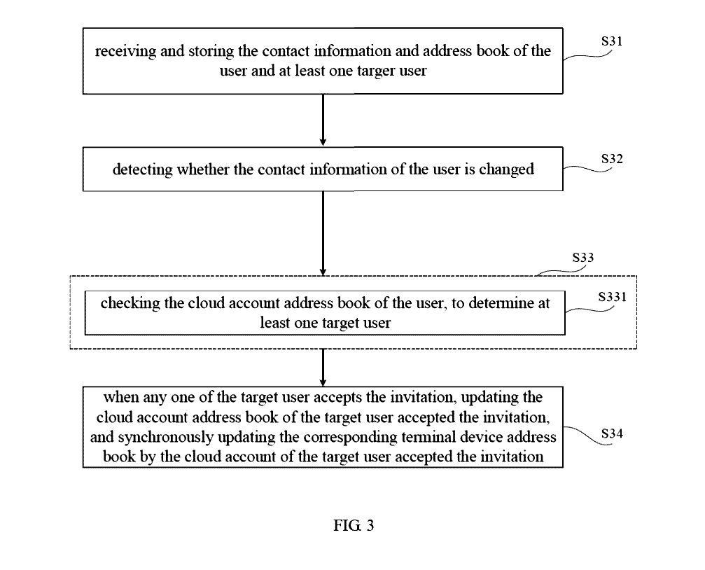

Referring to FIG. 3, a step flow diagram of another embodiment of the method for synchronously updating contact information of the present disclosure is shown. The method for synchronously updating contact information can include the steps as follows.

S31, receiving and storing the contact information and address book of the user and at least one target user.

Wherein, the contact information can include telephone number and/or cell phone number and/or social account such as CLQ number, WeChat, etc.

S32, detecting whether the contact information of the user is changed.

S33, when the contact information of the user is changed, updating the cloud account contact information of the user, and sending the contact information synchronous update invitation to the terminal device of at least one target user in the cloud account address hook of the user; wherein, the cloud account of the at least one target user and the cloud account of the user are in the same cloud server, and the cloud account address book of each of the target user include the contact information of the user before change; wherein, after updating the cloud account contact information of the user and before sending the contact information synchronous update invitation to the terminal device of at least one target user in the cloud account address book of the user; further including steps as follows.

S331, checking user's cloud account address book, to determine at least one target user:

Wherein, the cloud account contact information of the user is the contact information stored in the cloud account of the user, the cloud address book of the user is the address book stored in the cloud account of the user, the change of the contact information of the user can automatically or manually synchronize the changed contact information to the cloud account of the user after the corresponding contact information in the user's own terminal device is changed. Then, step S32 can compare the contact information of the user after synchronization with the stored user's cloud account contact information before synchronization. If they are different, it is judged that the contact information of the user is changed, and then enters into step S33. Specifically, the terminal device of at least one target user and the terminal device for the user own can be cell phone, etc.

Since the cloud account address book of the user includes the contact information of at least one target user, the cloud account address book of each of the target user includes the contact information of the user before changed, i.e. the user and each target user used to keep in touch, for example, the user and each target user are friends. Therefore, step S33 sends the contact information synchronous update invitation to the terminal device of at least one user in the cloud account address book of the user, which can save the trouble that the user informs at least one target user one by one that the contact information is changed. Specifically, the forms of the contact information synchronous update invitation can include one or more form of the short message, the pushing information of the application program, the pushing information of the social system, etc. Wherein, in one embodiment of the present disclosure, the contact information synchronous update invitation can include the contact information of the user before and after the change, and the options whether to accept to synchronously update his own address book, and so on. Thereby, the at least one target user can learn the change of the contact information of the user. and can determine whether to accept the invitation or not according to the need.

Further, when the target user accepts the invitation, the target user can choose to accept the option to synchronously update his own address book and make a response or use other manners to accept the invitation. Then, it means that the target user who accepts the invitation needs to keep in touch with the user, and enters into the step S34.

S34, when any one of the target user accepts the invitation. updating the cloud account address book of the target user who accepts the invitation, and synchronously updating the corresponding terminal device address book through the cloud account of the target user who accepts the invitation.

Wherein, step S34 updates the cloud account address book of the target user who accepts the invitation, it can replace the contact information of the user before change in the cloud account address book with the contact information of the user after change. Step S34 synchronously updates the corresponding terminal device address book through the cloud account of the target user who receives the invitation, for the cloud account of the target user received the invitation, the contact information of the user before change in the cloud account address book is used to replace the contact information of the user after change, or the terminal device address account is used to replace updated cloud account address book.

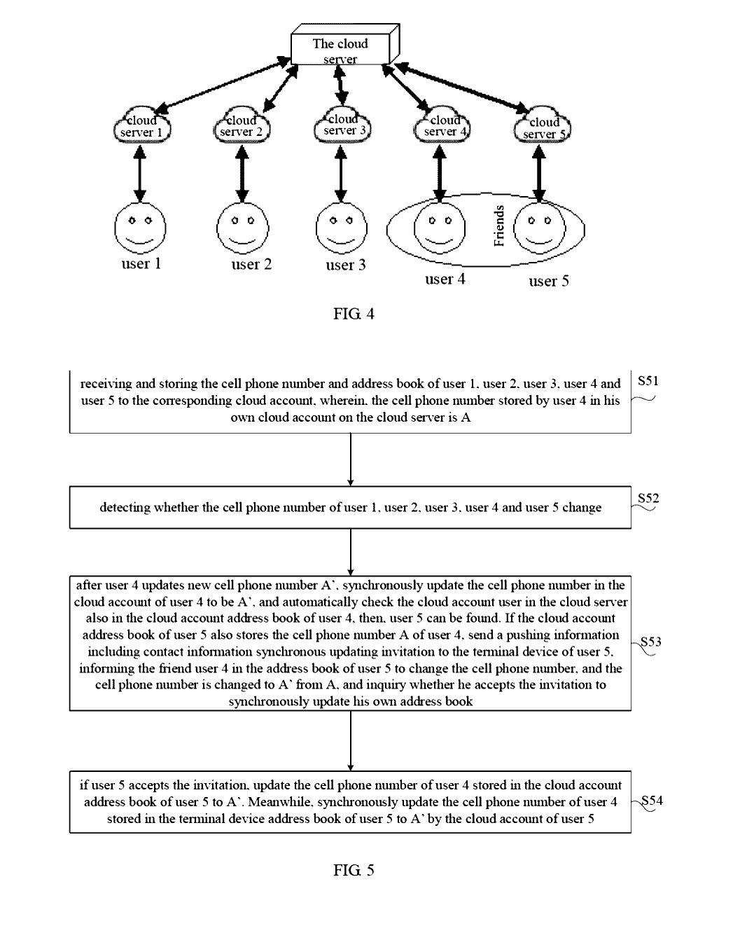

In one specific embodiment of the present disclosure, see FIG. 4, user 1, user 2, user 3, user 4 and user 5 are under the same cloud server, wherein user 1 correspondingly has cloud account 1, user 2 correspondingly has cloud account 2, user 3 correspondingly has cloud account 3, user 4 correspondingly has cloud account 4, user 5 correspondingly has cloud account 5. The user 1, user 2, user 3, user 4 and user 5 respectively upload cell phone number and address book onto the corresponding cloud account, wherein user 4 and user 5 are friends. See FIG. 5, the method for synchronous updating contact information can include the following steps: Step S51, receiving and storing the cell phone number and address book of user 1, user 2, user 3, user 4 and user 5 to the corresponding cloud account, wherein, the cell phone number stored by user 4 in his own cloud account on the cloud server is A.

Step S52, detecting whether the cell phone number of user 1, user 2, user 3, user 4 and user 5 are changed.

Step S53, after user 4 updates new cell phone number A′, synchronously updating the cell phone number in the cloud account of user 4 to be A′, and automatically checking the cloud account user in the cloud server which is also in the cloud account address book of user 4, then, user 5 can be found. If the cloud account address book of user 5 also stores the cell phone number A of user 4, a pushing information including contact information synchronous update invitation is sent to the terminal device for user 5 to inform the friend user 4 in the address book of user 5 to change the cell phone number, and the cell phone number is changed to A′ from A, and inquiring whether to accept the invitation to synchronously update his own address book.

Step S54, if user 5 accepts the invitation, updating the cell phone number of user 4 stored in the cloud account address book of user 5 to A′. Meanwhile, synchronously updating the cell phone number of user 4 stored in the terminal device address book of user 5 to A′ by the cloud account of user 5.

According, to the Second embodiment of the present disclosure, after receiving and storing the contact information and address book of the user and at least one target user. detecting whether the contact information of the user such as telephone number and/or social account is changed; when the contact information of the user is changed, updating the cloud account contact information of the user, checking the cloud account address book of the user, to determine at least one target user, and sending the invitation for synchronously updating the contact information to the terminal device of at least one target user in the cloud account address book of the user; wherein, the cloud account of the at least one target user and the cloud account of the user are under the same cloud server, and the cloud account address book of each of the target user includes the contact information of the user before change, and when any one of the target user accepts the invitation, updating the cloud account address book of the target user who accepts the invitation, and synchronously updating the corresponding terminal device address book by the cloud account of the target user who accepts the invitation. Thereby, when the contact information of any one of the user is changed, all of the target user under the cloud server con automatically receive the contact information synchronous update invitation, which saves the trouble that the user informs the target user one by one about the change of the contact information, and can update the address book and the terminal device address book of the target user who accepts the invitation m time, thereby avoiding the problem of poor communication between the user, and improve user experience.

### Third Embodiment

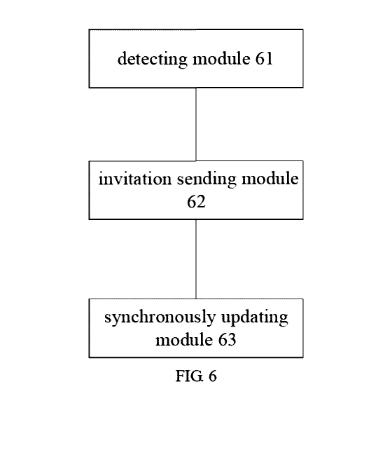

See FIG. 6, a structure diagram of an embodiment of the device for synchronously updating contact information of the present disclosure is shown. The device for synchronously updating contact information can include modules as follows.

A detecting module 61, for detecting whether the contact information of the user is changed.

Wherein, the contact information can include telephone number an/or cell phone number and/or social account such as QQ number, WeChat, etc.

An invitation sending module 62, for updating the cloud account contact information of the user, and sending the contact information synchronous update invitation to the terminal device of at least one target user in the cloud account address book of the user when the contact information of the user is changed; wherein, the cloud account of the at least one target user and the cloud account of the user are under the same cloud server, and the cloud account address book of each of the target user includes the contact information of the user before change.

Wherein, the cloud account contact information of the user is the contact information stored in the cloud account of the user, the cloud address book of the user is the address book stored in the cloud account of the user. Specifically, the terminal device of at least one target user can be cell phone, etc. Specifically, the forms of the contact information synchronous update invitation can include one or more form of the short message, the pushing information of the application program, the pushing information of the social system, etc.

Since the cloud account address book of the user includes the contact information of at least one target user, the cloud account address book of each of the target user includes the contact information of the user before changed, i.e. the user and each target user used to keep in touch, for example, the user and each target user are friends. Therefore, the invitation sending module 62 sends the contact information synchronous update invitation to the terminal device of at least one user in the cloud account address book of the user, and it can save the trouble that the user informs at least one target user one by one contact information one by one. Further, when the target user accepts the invitation, that is to say, the target user accepted the invitation need to keep in touch with the user, entering into a synchronously updating module 63.

The synchronously updating module 63, when any one of the target user accepts the invitation, updating the cloud account address book of the target user accepted the invitation, and synchronous updating the corresponding terminal device address book by the cloud account of the target user accepted the invitation.

Wherein, the synchronously updating module 63 updates the cloud account address book of the target user accepted the invitation, it can replace the contact information of the user before changed in the cloud account address book with the contact information of the user after changed. The synchronously updating module 63 synchronously updates the corresponding terminal device address book by the cloud account of the target user received the invitation, it can be for the cloud account of the target user received the invitation, replace the contact information of the user before changed in the cloud account address book with the contact information of the user after changed, or replace the terminal device address account with updated cloud account address book.

According to the third embodiment of the present disclosure, after detecting whether the contact information of the user such as telephone number and/or social account is changed, when the contact information of the user is changed, update the cloud account contact information of the user, and send the invitation for synchronously updating the contact information to the terminal device of at least one target user in the cloud account address book of the user; wherein, the cloud account of the at least one target user and the cloud account of the user are in the same cloud server, and the cloud account address book of each of the target user include the contact information of the user before changed, and when any one of the target user accepts the invitation, updating the cloud account address book of the target user accepted the invitation, and synchronously updating the corresponding terminal deice address book by the cloud account of the target user accepted the invitation. Thereby, when the contact information of any One of the user is changed, all of the target user under the cloud server can automatically receive the contact information synchronously updating invitation, omitting the trouble of the user telling the target user one by one about the change of the contact information, and can update the address book and the terminal device address book of the target user accepted the invitation in time, thereby avoiding the problem of poor communication between the user, and improve user experience.

### Fourth Embodiment

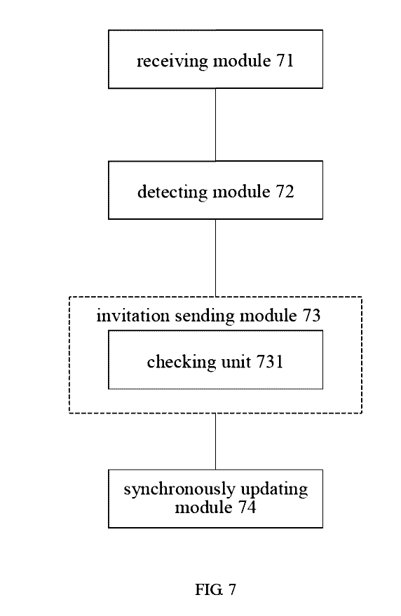

See FIG. 7, a structure diagram of another embodiment of the device for synchronously updating contact information of the present disclosure is shown. The device for synchronously updating contact information can include:

A receiving module 71, for receiving and storing the contact information and address book of the user and at least one target user.

Wherein, the contact information can include telephone number and/or cell phone number and/or social account such as QQ number, WeChat, etc.

A detecting module 72, for detecting whether the contact information of the user is changed.

An invitation sending module 73, for when the contact information of the user is changed, updating the cloud account contact information of the user, and sending the invitation for synchronously updating the contact information to the terminal device of at least one target user in the cloud account address book of the user wherein, the cloud account of the at least one target user and the cloud account of the user are in the same cloud server, and the cloud account address book of each of the target user include the contact information of the user before changed; the invitation sending module 73 can include the follows.

A checking unit 731, for after updating the cloud account contact information of the user, and before sending the invitation for synchronously updating the contact information to the terminal device of at least one target user in the cloud account address book of the user, checking user's cloud account address book, to determine at least one target user.

Wherein, the cloud account contact information of the user is the contact information stored in the cloud account of the user, the cloud address book of the user is the address book stored in the cloud account of the user, the change of the contact information of the user can automatically synchronize or manual synchronize the changed contact information to the cloud account of the user after the change of the corresponding contact information in the user's own terminal device. Then, the checking module 72 can compare the contact information of the user after synchronization with the stored user's cloud account contact information before synchronization. If different, it can be determined that the contact information of the user is changed, entering the invitation sending module 73. Specifically, the terminal device of at least one target user and the terminal device for the user own can be cell phone, etc.

Since the cloud account address book of the user include the contact information of at least one target user, the cloud account address book of each of the target user include the contact information of the user before changed, i.e. the user and each target user used to keep in touch, for example, the user and each target user are friends. Therefore, the invitation sending module 73 sends the contact information synchronously updating invitation to the terminal device of at least one user in the cloud account address book of the user, and it can omit the trouble that the user tell at least one target user his changed contact information one by one. Specifically, the forms of the contact information synchronously updating invitation can include one or more form of the short message. the pushing information of the application program, the pushing information of the social system. etc. Wherein, in one embodiment of the present disclosure, the contact information synchronously updating invitation can include the contact information of the user before and after changed, and the options of whether he accepts to synchronously update his own address book, etc. Thereby, the at least one target user can obtain the change of the contact information of the user, and can determine whether to accept the invitation according to the need.

Further, when the target user accepts the invitation, the target user can choose to accept the synchronously updating his own address book option and response or use other manners to accept the invitation. Then, that is to say, the target user accepted the invitation need to keep in touch with the user, entering into the synchronously updating module 74.

The synchronously updating 74, for when any one of the target user accepts the invitation, updating the cloud account address book of the target user accepted the invitation, and synchronously updating the corresponding terminal device address book by the cloud account of the target user accepted the invitation.

Wherein, the synchronously updating 74 updates the cloud account address hook of the target user accepted the invitation, it can replace the contact information of the user before changed in the cloud account address book with the contact information of the user after changed. The synchronously updating 74 synchronously updates the corresponding terminal device address book by the cloud account of the target user received the invitation, it can be for the cloud account of the target user received the invitation, replace the contact information of the user before changed in the cloud account address book with the contact information of the user after changed, or replace the terminal device address account with updated cloud account address book.

According to the fourth embodiment of the present disclosure, after the receiving module receiving and storing the contact information and address book of the user and at least one target user, the detecting module detecting whether the contact information of the user such as telephone number and/or social account is changed, when the contact information of the user is changed, the invitation sending module updating the cloud account contact information of the user, the checking unit in the invitation sending module checking the cloud account address book of the user, to determine at least one target user, and the invitation sending module sending the invitation for synchronously updating the contact information to the terminal device of at least one target user in the cloud account address book of the user, wherein, the cloud account of the at least one target user and the cloud account of the user are in the same cloud server, and the cloud account address book of each of the target user include the contact information of the user before changed, and when any one of the target user accepts the invitation, the synchronously updating module updating the cloud account address book of the target user accepted the invitation, and synchronously updating the corresponding terminal device address book by the cloud account of the target user accepted the invitation. Thereby, when the contact information of any one of the user is changed, all of the target user under the cloud server can automatically receive the contact information synchronously updating invitation, omitting the trouble of the user telling the target user one by one about the change of the contact information, and can update the address book and the terminal device address book of the target user accepted the invitation in tune, thereby avoiding the problem of poor communication between the user, and improve user experience.

The above described device embodiments are only schematic, wherein the unit as the separate component can be or can, be not separate physically. The component shown as the unit can be or can be not a physical unit, i.e. can lie in one place, or can distribute on a plurality of network units. A portion or entire modules can be chosen to achieve the purpose of the present embodiment according to actual need. A person skilled in the art can understand and carry out, under the circumstance without creative work.

Each of devices according to the embodiments of the disclosure can be implemented by hardware, or implemented by software modules operating on one or more processors, or implemented by the combination thereof A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

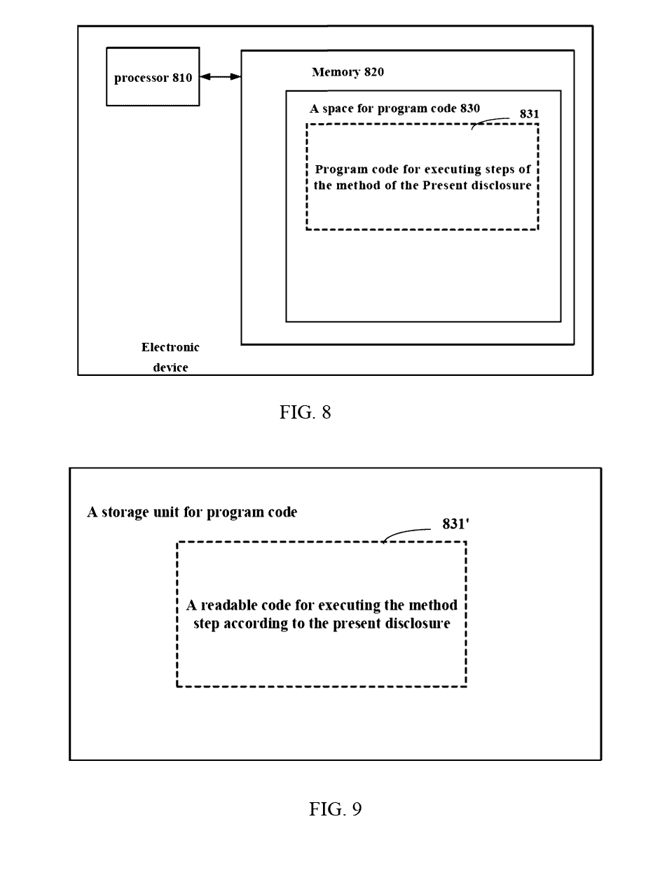

For example, FIG. 8 illustrates a block diagram of an electronic device for executing the method according the disclosure, the electronic device may be an application server above. Traditionally, the electronic device includes a processor 810 and a computer program product or a computer readable medium in form of a memory 820. The memory 820 could be electronic memories such as flash memory, EEPROM (Electrically Erasable Programmable Read—Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 9. The memory cells may be provided with memory sections, memory spaces, etc., similar to the memory 820 of the electronic device as shown in FIG. 8. The program codes may be compressed for example in an appropriate Iona Usually, the memory cell includes computer readable codes 831′ which can be read for example by processors 810. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”. etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

It should be described in the end: the above embodiments are only used for describing the technical scheme of the present disclosure, rather than a limitation. In spite of seeing the previous embodiments, the present disclosure is described in details, a person skilled in the art shall understand: the technical scheme recorded in each of the previous embodiments still can be amended, or portions of technical features therein can be replaced by equivalent. Such amendment or replacement cannot make the essence of corresponding technical scheme break away from the spirit and scope of each embodiment technical scheme of the present disclosure.

What is claimed is:

1. A method for synchronously updating contact information, comprising:
detecting whether the contact information of user is changed;
when the contact information of the user is changed, updating the cloud account contact information of the user, and sending the invitation for synchronously updating the contact information to terminal device of at least one target user in the cloud account address hook of the user; wherein, the cloud account of the at least one target user and the cloud account of the user are belong to the same cloud server, and the cloud account address book of each of the target user comprises the contact information of the user before changed;
when any one of the target user accepts the invitation, updating the cloud account address book of the target user accepted the invitation, and synchronously updating the corresponding terminal device address book by the cloud account of the target user accepted the invitation.

2. The method according to claim 1, wherein before the detecting whether the contact information of the user is changed, further comprises:
receiving and storing the contact information and address book of the user and the at least one target user.

3. The method according to claim 1, wherein after the updating the cloud account contact information of the user. and the before sending the invitation for synchronously updating the contact information to the terminal device of at least one target user in the cloud account address book of the user, the method further comprises:
checking the cloud account address book of the user, to determine the at least one target user.

4. The method according to claim 1, wherein the forms of the contact information synchronously updating invitation comprise one or more form of a short message, a pushing information of the application program, a pushing information of the social system.

5. The method according to claim 1, wherein the contact information comprises telephone number or social account.

6. An electronic device for synchronously updating contact information, comprising:
at least one processor; and
a memory communicably connected with the at least one processor for storing instructions executable by the at least one processor, wherein execution of the instructions b the at least one processor causes the at least one processor to:
detect whether the contact information of user is changed;
when the contact information of the user is changed, update the cloud account contact information of the user, and send the invitation for synchronously updating the contact information to the terminal device of at least one target user in the cloud account address book of the user; wherein, the cloud account of the at least one target user and the cloud account of the user are in the same cloud server, and the cloud account address book of each of the target user comprise the contact information of the user before changed;
when any one of the target user accepts the invitation, update the cloud account address book of the target user accepted the invitation, and synchronously update the corresponding terminal device address book by the cloud account of the target user accepted the invitation.

7. The electronic device according to claim 6, wherein execution of the instructions by the at least one processor further causes the at least one processor to:
receive and storing the contact information and address book of the user and the at least one target user.

8. The electronic device according to claim 6, wherein when the contact information of the user is changed, update the cloud account contact information of the user, and send the contact information synchronous updating invitation to the terminal device of at least one target user in the cloud account address book of the user comprises:
after the updating the cloud account contact information of the user, and before the sending the invitation for synchronously updating the contact information to the terminal device of at least one target user in the cloud account address book of the user, checking the cloud account address book of the user, to determine the at least one target user.

9. The electronic device according to claim 6, wherein the forms of the contact information synchronously updating invitation comprise one or more form of a short message, a pushing information oldie application program, a pushing information of the social system.

10. The electronic device according to claim 6, wherein the contact information comprises telephone number or social account.

11. A non-transitory computer-readable medium storing executable instructions that, when executed by a computing device, cause the computing device to:
detect whether the contact information of user is changed;
when the contact information of the user is changed, update the cloud account contact information of the user, and send the invitation for synchronously updating the contact information to the terminal device of at least one target user in the cloud account address book of the user; wherein, the cloud account of the at least one target user and the cloud account of the user are in the same cloud server, and the cloud account address book of each of the target user comprise the contact information of the user before changed;
when any one of the target user accepts the invitation, update the cloud account address book of the target user accepted the invitation, and synchronously update the corresponding terminal device address book by the cloud account of the target user accepted the invitation.

12. The non-transitory computer-readable medium according to claim 11, Wherein the electronic device is thither caused to:
receive and storing the contact information and address book of the user and the at least one target user.

13. The non-transitory computer-readable medium according to claim 11, wherein when the contact information of the user is changed, update the cloud account contact information of the user, and send the contact information synchronous updating invitation to the terminal device of at least one target user in the cloud account address book of the user comprises:
after the updating the cloud account contact information of the user, and before the sending the invitation for synchronously updating the contact information to the terminal device of at least one target user in the cloud account address book of the user, checking the cloud account address book of the user, to determine the at least one target user.

14. The non-transitory computer-readable medium according to claim 11, wherein the forms of the contact information synchronously updating invitation comprise one or more form of a short message, a pushing information of the application program, a pushing information of the social system.

15. The non-transitory computer-readable medium according to claim 11, wherein the contact information comprises telephone number or social account.
